(19) United States
(12) Patent Application Publication
(10) Pub. No.: US 2015/0234103 A1
(43) Pub. Date: Aug. 20, 2015

(54) FILM STRUCTURE

(71) Applicants: Kuo-Teng Hsu, Hsinchu (TW); Chih-Tsung Lu, Hsinchu (TW); Tse-Hung Hsiao, Hsinchu (TW); Yi-Chang Lin, Hsinchu (TW); Chia-Feng Chen, Hsinchu (TW); Lie-Zen Chung, Hsinchu (TW)

(72) Inventors: Kuo-Teng Hsu, Hsinchu (TW); Chih-Tsung Lu, Hsinchu (TW); Tse-Hung Hsiao, Hsinchu (TW); Yi-Chang Lin, Hsinchu (TW); Chia-Feng Chen, Hsinchu (TW); Lie-Zen Chung, Hsinchu (TW)

(73) Assignee: KOATECH TECHNOLOGY CORPORATION, Hsinchu Hsien (TW)

(21) Appl. No.: 14/291,018

(22) Filed: May 30, 2014

(30) Foreign Application Priority Data
Feb. 19, 2014 (TW) 103105538

(51) Int. Cl. G02B 5/20; C09J 11/06; C08K 5/10; C09J 133/08

(52) U.S. Cl. CPC G02B 5/208; C09J 133/08; C09J 11/06; C08K 5/10

(57) ABSTRACT

A film structure including a substrate, a coating layer, and an adhesive layer is provided. The coating layer and the adhesive layer are respectively disposed on two opposite surfaces of the substrate. The adhesive layer includes a chemical composition for filtering a light ray. The adhesive layer cuts off the light ray in a specific wavelength range when the light ray passes through the adhesive layer. A cut-off rate of the light ray in a wavelength range of 380 nm to 420 nm is greater than 80%.

### CROSS-REFERENCE TO RELATED APPLICATION

This application claims the priority benefit of Taiwan application serial no. 103105538, filed on Feb. 19, 2014. The entirety of the above-mentioned patent application is hereby incorporated by reference herein and made a part of this specification.

### BACKGROUND OF THE INVENTION

1. Field of the Invention

The invention relates to a film structure and more particularly relates to a film structure for eye protection.

2. Description of Related Art

In the current electronic products, high-brightness light emitting diodes (LEDs) are usually used as the backlight sources in order that the screens have high brightness. However, the light emitted from LEDs includes a light ray in a wavelength range of 380 nm to 420 nm. The light ray in the wavelength range of 380 nm to 420 nm may pass through the crystalline lens and reach the macula of the retina, which causes decline of the retinal pigment epithelial cells and death of photosensitive cells. Eventually, macular degeneration may occur and result in decreased vision or even loss of vision.

In order to reduce the harm that the light ray in the wavelength range of 380 nm to 420 nm may cause to the human eyes, a film structure has been developed to be adhered to the screen of electronic product. The film structure on the screen of the electronic product may cut off light in a specific wavelength range (e.g. 380 nm to 420 nm) so as to reduce the harm that the light of the screen may cause to the human eyes. According to the conventional technology, however, some film structures are composed of a large number of films. As a result, the film structures are very thick. When such film structures are adhered to the screen, they may have adverse effects on the appearance of the electronic product. On the other hand, some film structures may have high transmittance to visible light in the wavelength range of 400 nm to 700 nm but have a low blocking rate to the light ray in the wavelength range of 380 nm to 420 nm, and cannot properly protect the eyes of the user.

### SUMMARY OF THE INVENTION

The invention provides a film structure, which includes fewer layers and has a high cut-off rate with respect to a light ray in a wavelength range of 380 nm to 420 nm.

A film structure of the invention includes a substrate, a coating layer, and an adhesive layer. The coating layer and the adhesive layer are respectively disposed on two opposite surfaces of the substrate. The adhesive layer includes a light filtering compound. The adhesive layer cuts off a light ray in a specific wavelength range when the light ray passes through the film structure. A cut-off rate of the adhesive layer with respect to a light ray in a wavelength range of 380 nm to 420 nm is greater than 80%.

In an embodiment of the invention, the cut-off rate of the adhesive layer with respect to a light ray in a wavelength range of 400 nm or less is 99.9%.

In an embodiment of the invention, the cut-off rate of the film structure with respect to a light ray in a wavelength range of 400 nm to 500 nm is greater than or equal to 20%.

In an embodiment of the invention, the film structure is adapted to be adhered to an object through the adhesive layer, and a first wetting speed of the adhesive layer with respect to the object is less than or equal to 0.1 sec/cm².

In an embodiment of the invention, the adhesive layer further includes a colloid. The light filtering compound is distributed in the colloid, and the colloid includes an acrylic polymer, a fatty acid ester-based plasticizer, and a curing agent.

In an embodiment of the invention, the viscosity of the colloid is in a range of 1 cps to 10,000 cps.

In an embodiment of the invention, the viscosity of the colloid is in a range of 500 cps to 5,000 cps.

In an embodiment of the invention, a structural formula of the acrylic polymer is:

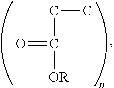

wherein R is a methyl group, an ethyl group, a butyl group, a hydrocarbon group, or a combination of the foregoing.

In an embodiment of the invention, a structural formula of the fatty acid ester-based plasticizer is:

(R—COOR′)

, wherein R is a 12-18 carbon alkyl group, and R′ is a methyl group or an ethyl group.

In an embodiment of the invention, the colloid includes a polyurea ester crosslinked structure having a structural formula of:

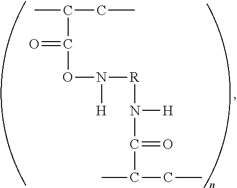

wherein R is aromatic or aliphatic.

In an embodiment of the invention, the thickness of the colloid is in a range of 15 μm to 100 μm.

In an embodiment of the invention, the thickness of the colloid is in a range of 25 μm to 75 μm.

In an embodiment of the invention, the light filtering compound includes benzophenone, a benzophenone derivative, phenylazophenyl, a phenylazophenyl derivative, benzotriazole, a benzotriazole derivative, or a combination of the foregoing.

In an embodiment of the invention, the light filtering compound is 10% to 50% of a solid content of the colloid.

In an embodiment of the invention, the light filtering compound is 20% to 40% of the solid content of the colloid.

In an embodiment of the invention, a ratio of the colloid to the light filtering compound is 1:1 and the thickness of the adhesive layer is 33 μm.

In an embodiment of the invention, the ratio of the colloid to the light filtering compound is 2:1 and the thickness of the adhesive layer is 50 μm.

Based on the above, in the film structure of an embodiment of the invention, the adhesive layer is provided with the light filtering compound. That is, the film structure of an embodiment of the invention integrates the light filtering and adhesive functions in the same film layer. Accordingly, the number of the films in the film structure is reduced, such that the film structure does not affect the appearance of the object when adhered to the object.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic diagram of a film structure according to an embodiment of the invention.

FIG. 2A to FIG. 2C schematically illustrate a process of performing an abrasion test on a coating layer according to an embodiment of the invention.

FIG. 3A to FIG. 3B schematically illustrate a process of performing an exhaust test on an adhesive layer according to an embodiment of the invention.

FIG. 4 illustrates a transmittance spectrum of a film structure of an embodiment of the invention and a transmittance spectrum of a commercially available film structure.

### DESCRIPTION OF THE EMBODIMENTS

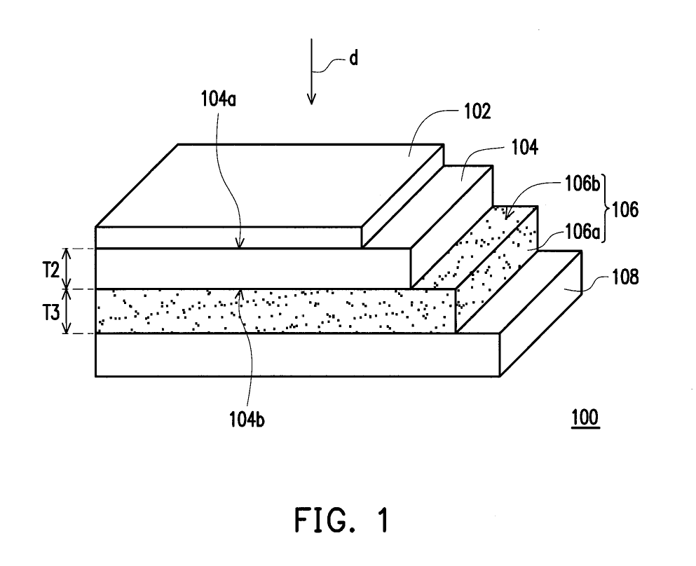

FIG. 1 is a schematic diagram of a film structure according to an embodiment of the invention. Referring to FIG. 1, a film structure 100 of this embodiment includes a coating layer 102, a substrate 104, and an adhesive layer 106 that are stacked in sequence in a direction d. In this embodiment, the adhesive layer 106 includes a colloid 106a and a light filtering compound 106b distributed in the colloid 106a. The light filtering compound 106b is provided to cut off a light ray in a specific wavelength range, which is 380 nm to 420 nm specifically. In this embodiment, the film structure 100 may selectively include a release film 108. The adhesive layer 106 is disposed between the substrate 104 and the release film 108. When the user intends to use the film structure 100, the release film 108 is removed to allow the adhesive layer 106 to be in contact with an object (e.g. a screen of an electronic product or eyeglass lenses of the user) for adhering the film structure 100 onto the object. However, it is noted that the film structure 100 of the invention does not necessarily include the release film 108. Whether the release film 108 is included in the film structure 100 may be determined according to the actual requirements.

In this embodiment, the coating layer 102 may be a light curable film, such as an ultraviolet light curable film. Before curing, the coating layer 102 includes a multi-functional prepolymer, a light curing initiator, a diluent, and a solvent. Before curing, the viscosity of the coating layer 102 may be in a range of 1 cps to 10,000 cps, particularly in a range of 10 cps to 100 cps. The multi-functional prepolymer of the coating layer 102 may be a multi-functional polyurethane prepolymer. More specifically, the multi-functional prepolymer of the coating layer 102 may be a 3-6 multi-functional polyurethane prepolymer. A solid content of the 3-6 multi-functional polyurethane prepolymer is 20% to 80%, particularly 30% to 60%, of an overall solid content of the coating layer 102. A functional group of the multi-functional prepolymer of the coating layer 102 is an acrylic functional group. The multi-functional prepolymer including the acrylic functional group is a non-yellowing polyurethane prepolymer. The diluent of the coating layer 102 is an acrylic monomer having a reactive functional group. The solvent of the coating layer 102 is ketones or esters, for example. The solvent is used to adjust the viscosity and coating properties of the coating layer 102 before curing.

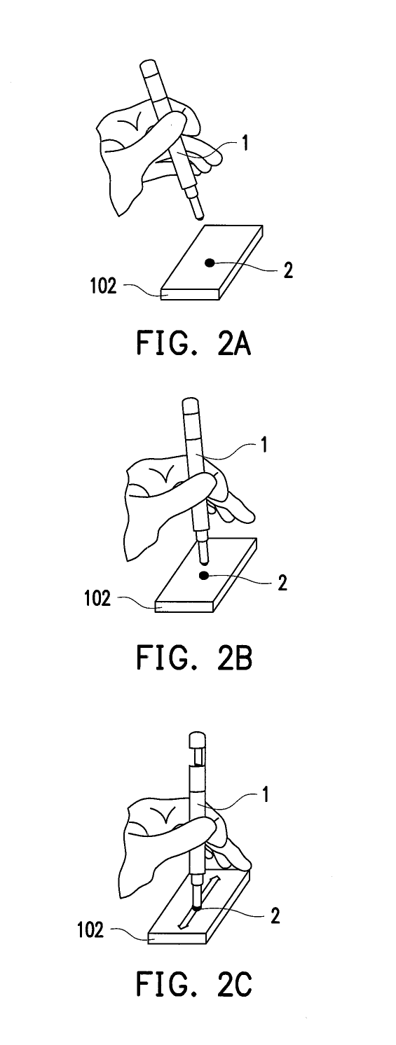

After curing, the coating layer 102 of this embodiment has high hardness, which is shown by the coating layer abrasion test and the abrasion test result, illustrated in FIG. 2A to FIG. 2C. FIG. 2A to FIG. 2C schematically illustrate a process of performing an abrasion test on a coating layer according to an embodiment of the invention. Referring to FIG. 2A, first, a load pen 1 and a steel wool 2 were provided, wherein the specification of the steel wool 2 was #0000, and the steel wool 2 was disposed on the coating layer 102 to be tested. Referring to FIG. 2B, then, the load pen 1 accurately pressed the steel wool 2 disposed on the coating layer 102. Referring to FIG. 2C, thereafter, the load pen 1 was used to apply a specific weight (e.g. 500 grams in this embodiment) on the steel wool 2. Next, while the specific weight applied on the steel wool 2 was maintained, the load pen 1 and the steel wool 2 were moved back and forth to rub the steel wool 2 against the coating layer 102. According to the test result, after performing the abrasion test shown in FIG. 2A to FIG. 2C to move the load pen 1 and the steel wool 2 back and forth 20 times, no scratch was found in the surface of the coating layer 102 of this embodiment. This abrasion test shows that the coating layer 102 of this embodiment has high hardness or high abrasion resistance.

With reference to FIG. 1, the coating layer 102 having high hardness is capable of protecting the substrate 104 and the adhesive layer 106 disposed thereunder. What is more, in this embodiment, the coating layer 102 further includes nano-pigment black to cut off the light ray in a specific wavelength range (400 nm to 500 nm), so as to further increase a cut-off rate of the film structure 100 with respect to the light ray of 400 nm to 500 nm to 20% or more. That is, in addition to cutting off the light ray in the specific wavelength range with the adhesive layer 106, the film structure 100 further uses the coating layer 102 to help cut off the light ray in the specific wavelength range, so as to achieve better effects in eye protection. In this embodiment, the content of the nano-pigment black is 0.1% to 30% of the overall content of the coating layer 102. Nevertheless, it is noted that the invention is not limited thereto.

The coating layer 102 and the adhesive layer 106 are respectively disposed on two opposite surfaces 104a and 104b of the substrate 104. Further, in this embodiment, the substrate 104 is formed of one material that has the same properties. The two opposite surfaces 104a and 104b of the substrate 104 are in contact with the coating layer 102 and the adhesive layer 106 respectively. The material of the substrate 104 is polyethylene terephthalate (PET) or polycarbonate (PC), for example. A thickness T2 of the substrate 104 in the direction d is in a range of 50 nm to 175 nm, for example. However, it is noted that the invention is not limited thereto.

The adhesive layer 106 of this embodiment is a heat curable adhesive. Before curing, the adhesive layer 106 includes an acrylic polymer, a fatty acid ester-based plasticizer, and a curing agent. Before curing, the viscosity of the adhesive layer 106 is in a range of 1 cps to 10,000 cps, particularly in a range of 500 cps to 5,000 cps, for example. A structural formula of the acrylic polymer of the adhesive layer 106 is shown as follows:

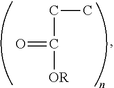

wherein R may be a methyl group, an ethyl group, a butyl group, or a hydrocarbon group, etc. A structural formula of the fatty acid ester-based plasticizer of the adhesive layer 106 is shown as follows:

(R—COOR′)

, wherein R may be a 12-18 carbon alkyl group, and R′ may be a methyl group or an ethyl group, etc. A structural formula of the curing agent of the adhesive layer 106 is shown as follows:

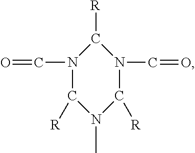

wherein R may be aromatic or aliphatic.

After heat curing, a chemical formula of a polyurea ester crosslinked structure of the adhesive layer 106 is as follows:

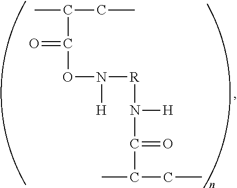

wherein R is aromatic or aliphatic. A thickness T3 of the adhesive layer 106 in the direction d is in a range of 15 μm to 100 μm, particularly in a range of 25 μm to 75 μm, for example.

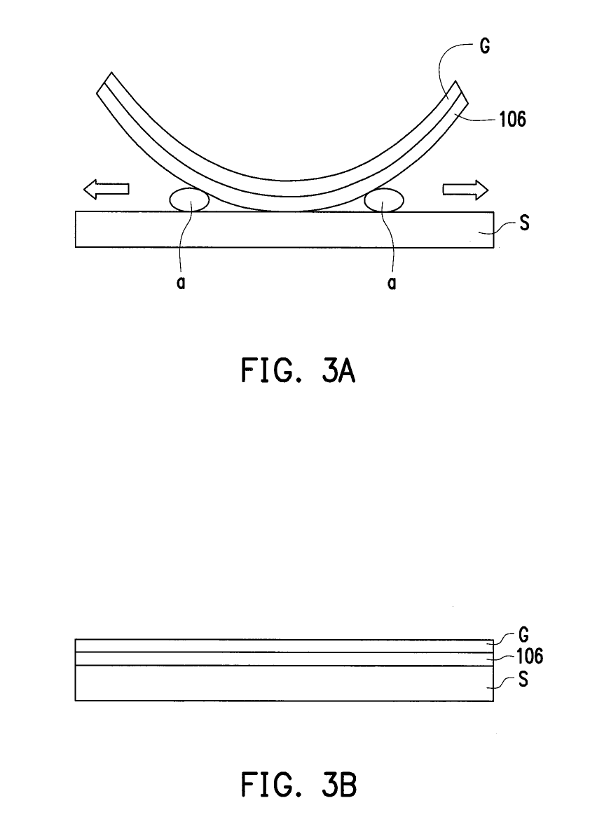

In this embodiment, the colloid 106a of the adhesive layer 106 is a specially-designed exhaust colloid. With use of the special exhaust design, the film structure 100 can be quickly adhered to the object to reduce bubbles remaining between the adhesive layer 106 and the object. FIG. 3A to FIG. 3B schematically illustrate a process of performing an exhaust test on an adhesive layer according to an embodiment of the invention. Referring to FIG. 3A, first, the adhesive layer 106 was formed on a standard substrate G, wherein an area of the adhesive layer 106 and an area of the standard substrate G were both A (e.g. 10 cm²). Then, the standard substrate G and the adhesive layer 106 were bent at the same time to bend the adhesive layer 106 toward an object S (e.g. glass). Next, the adhesive layer 106 bent toward the object S was made to gently touch the object S. Thereafter, as shown in the process of FIG. 3A to FIG. 3B, the standard substrate G and the adhesive layer 106 were released to measure a time T from the release of the standard substrate G and the adhesive layer 106 to complete attachment of the adhesive layer 106 on the object S (here, referring to a state that the adhesive layer 106 of the film structure 100 is completely adhered to the object S for the first time). At last, the time T was divided by the area A of the adhesive layer 106 to obtain a first wetting speed of the adhesive layer 106. In this embodiment, the first wetting speed of the adhesive layer 106 was very fast. As a result, as shown in FIG. 3A, air a existing between the adhesive layer 106 and the object S was quickly exhausted as the adhesive layer 106 was being adhered to the object S. Air bubbles did not remain between the adhesive layer 106 and the object S easily after the adhesive layer 106 was completely adhered to the object S. For example, in this embodiment, the first wetting speed of the adhesive layer 106 is less than or equal to 0.1 sec/cm². However, it is noted that the invention is not limited thereto.

The light filtering compound 106b of the adhesive layer 106 is a specially designed compound. The light filtering compound 106b effectively cuts off the light ray in the specific wavelength range (i.e. 380 nm to 420 nm). For example, in this embodiment, the light filtering compound 106b includes benzophenone, a benzophenone derivative, phenylazophenyl, a phenylazophenyl derivative, benzotriazole, a benzotriazole derivative, or a combination of the foregoing. A chemical formula of benzophenone is shown as follows:

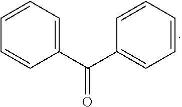 [SMILES: O=C(c1ccccc1)c1ccccc1]

A chemical formula of phenylazophenyl is shown as follows:

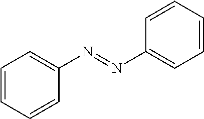 [SMILES: c1ccc(/N=N/c2ccccc2)cc1]

A chemical formula of benzotriazole is shown as follows:

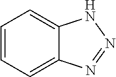

The light filtering compound 106b is 10% to 50%, particularly 20% to 40%, of a solid content of the adhesive layer 106.

It is worth mentioning that, by properly adjusting the ratio of the colloid 106a and the light filtering compound 106b and the thickness T3 of the adhesive layer 106 (shown in FIG. 1), the film structure 100 performs multiple excellent optical characteristics, such as high visible light transmittance and high blocking rate with respect to the light ray in the specific wavelength range (i.e. 380 nm to 420 nm). For example, if the ratio of the colloid 106a to the light filtering compound 106b is 1:1 and the thickness T3 of the adhesive layer 106 is 33 μm, or the ratio of the colloid 106a to the light filtering compound 106b is 2:1 and the thickness T3 of the adhesive layer 106 is 50 μm, the film structure 100 performs multiple excellent optical characteristics. Experimental data regarding comparison between the film structure 100 of an embodiment of the invention and a commercially available film structure is provided below.

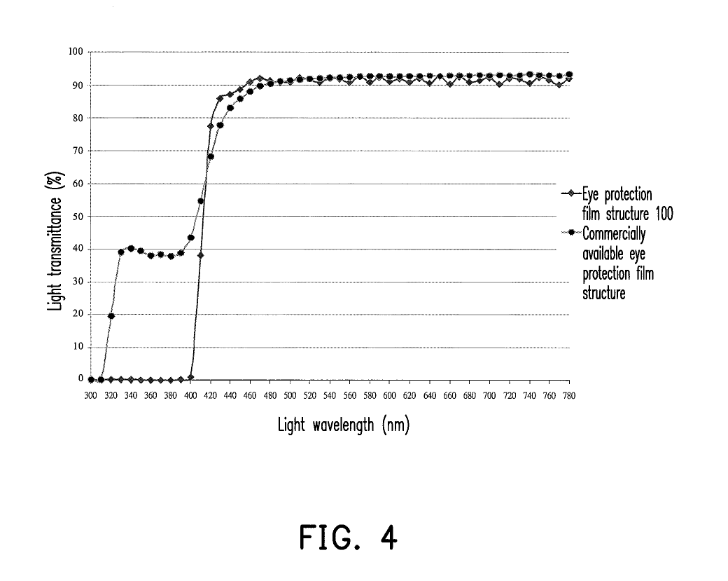

FIG. 4 illustrates a transmittance spectrum of the film structure of an embodiment of the invention and a transmittance spectrum of the commercially available film structure. It is known from FIG. 4 that the film structure 100 of an embodiment of the invention has low transmittance with respect to the light ray in the specific wavelength range (i.e. 380 nm to 420 nm) while the commercially available film structure has high transmittance with respect to the light ray in the specific wavelength range (i.e. 380 nm to 420 nm). It shows that the film structure 100 has a blocking rate higher than the commercially available film structure in terms of the light ray in the specific wavelength range (i.e. 380 nm to 420 nm). Moreover, it is known from FIG. 4 that, though the film structure 100 has high blocking rate with respect to the light ray in the specific wavelength range (i.e. 380 nm to 420 nm), the transmittance of the film structure 100 with respect to light in a visible light wavelength range (e.g. 400 nm to 700 nm) is maintained at approximately the same high level as the commercially available film structure.

Table 1 is a comparison table of the film structure of an embodiment of the invention and the commercially available film structure in terms of several characteristics. With reference to Table 1 below, the coating layer 102 of the film structure 100 in an embodiment of the invention has hardness approximating to that of the commercially available film structure. The transmittance of the film structure 100 with respect to visible light at the wavelength of 550 nm also approximates to the transmittance of the commercially available film structure. It is noted that a blocking rate of the film structure 100 is much higher than that of the commercially available film structure in terms of a blue-violet light ray in the wavelength range of 380 nm to 420 nm and in the wavelength range of 400 nm or less. In particular, the blocking rate of the film structure 100 is up to 80% with respect to the blue-violet light ray in the wavelength range of 380 nm to 420 nm and reaches 99.9% with respect to the blue-violet light ray in the wavelength range of 400 nm or less.

TABLE 1

| | Commercially available | |
|---|---|---|
| | film structure | Film structure 100 |
| Hardness of coating layer | 2 H | 3 H |
| Transmittance for visible | 92.25% | 91.99% |
| light at wavelength of | | |
| 550 nm | | |
| Blocking rate for | 68.8% | 99.9% |
| blue-violet light at | | |
| wavelength of 400 nm or | | |
| less | | |
| Blocking rate for | 52.57% | 80.48% |
| blue-violet light in | | |
| wavelength range of | | |
| 380 nm to 420 nm | | |

To sum up, in the film structure of an embodiment of the invention, the adhesive layer is provided with a light filtering compound. That is, the film structure of an embodiment of the invention integrates the light filtering and adhesive functions in the same film layer. Accordingly, the number of the films in the film structure is reduced, such that the film structure does not affect the appearance of the object when adhered to the object.

Moreover, the film structure of an embodiment of the invention is provided with the adhesive layer having a suitable thickness and a composition of the colloid and the light filtering compound in an appropriate ratio. With the adhesive layer, the film structure performs multiple excellent optical characteristics, and in particular, the film structure has high transmittance with respect to visible light and high blocking rate with respect to the light ray in the wavelength range that may easily cause harm to human eyes.

It will be apparent to those skilled in the art that various modifications and variations can be made to the structure of the disclosed embodiments without departing from the scope or spirit of the invention. In view of the foregoing, it is intended that the invention covers modifications and variations of this disclosure provided they fall within the scope of the following claims and their equivalents.

What is claimed is:

1. A film structure, comprising:
a substrate;
a coating layer; and
an adhesive layer, wherein the coating layer and the adhesive layer are respectively disposed on two opposite surfaces of the substrate, and the adhesive layer comprises a light filtering compound, wherein when light passes through the film structure, a light ray in a specific wavelength range is cut off by the adhesive layer, and a cut-off rate of the adhesive layer with respect to a light ray in a wavelength range of 380 nm to 420 nm is greater than 80%.

2. The film structure according to claim 1, wherein the cut-off rate of the adhesive layer with respect to a light ray in a wavelength range of 400 nm or less is 99.9%.

3. The film structure according to claim 1, wherein the cut-off rate of the film structure with respect to a light ray in a wavelength range of 400 nm to 500 nm is greater than or equal to 20%.

4. The film structure according to claim 1, wherein the film structure is adapted to be adhered to an object through the adhesive layer, and a first wetting speed of the adhesive layer with respect to the object is less than or equal to 0.1 sec/cm².

5. The film structure according to claim 1, wherein the adhesive layer further comprises a colloid, in which the light filtering compound is distributed, and the colloid comprises an acrylic polymer, a fatty acid ester-based plasticizer, and a curing agent.

6. The film structure according to claim 5, wherein the viscosity of the colloid is in a range of 1 cps to 10,000 cps.

7. The film structure according to claim 5, wherein the viscosity of the colloid is in a range of 500 cps to 5,000 cps.

8. The film structure according to claim 5, wherein a structural formula of the acrylic polymer is: 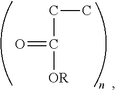
wherein R is a methyl group, an ethyl group, a butyl group, a hydrocarbon group, or a combination of the foregoing.

9. The film structure according to claim 5, wherein a structural formula of the fatty acid ester-based plasticizer is:
(R—COOR′)
, wherein R is a 12-18 carbon alkyl group, and R′ is a methyl group or an ethyl group.

10. The film structure according to claim 5, wherein a structural formula of the curing agent is: 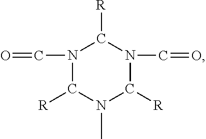
wherein R is aromatic or aliphatic.

11. The film structure according to claim 5, wherein the colloid comprises a polyurea ester crosslinked structure having a structural formula of: 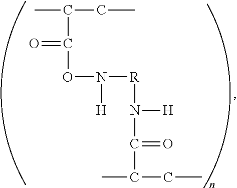
wherein R is aromatic or aliphatic.

12. The film structure according to claim 5, wherein the thickness of the colloid is in a range of 15 μm to 100 μm.

13. The film structure according to claim 5, wherein the thickness of the colloid is in a range of 25 μm to 75 μm.

14. The film structure according to claim 1, wherein the light filtering compound comprises benzophenone, a benzophenone derivative, phenylazophenyl, a phenylazophenyl derivative, benzotriazole, a benzotriazole derivative, or a combination of the foregoing.

15. The film structure according to claim 5, wherein the light filtering compound is 10% to 50% of a solid content of the colloid.

16. The film structure according to claim 5, wherein the light filtering compound is 20% to 40% of the solid content of the colloid.

17. The film structure according to claim 5, wherein a ratio of the colloid to the light filtering compound is 1:1 and the thickness of the adhesive layer is 33 μm.

18. The film structure according to claim 5, wherein the ratio of the colloid to the light filtering compound is 2:1 and the thickness of the adhesive layer is 50 μm.

19. The film structure according to claim 1, wherein the coating layer is a light curable film.

20. The film structure according to claim 19, wherein the coating layer before curing comprises a multi-functional prepolymer, a light curing initiator, a diluent, and a solvent.

21. The film structure according to claim 19, wherein the viscosity of the coating layer before curing is in a range of 1 cps to 10,000 cps.

22. The film structure according to claim 19, wherein the viscosity of the coating layer before curing is in a range of 10 cps to 100 cps.

23. The film structure according to claim 20, wherein the multi-functional prepolymer is a 3-6 multi-functional polyurethane prepolymer, which is 20% to 80% of an overall solid content of the coating layer.

24. The film structure according to claim 20, wherein the multi-functional prepolymer is a 3-6 multi-functional polyurethane prepolymer, which is 30% to 60% of the overall solid content of the coating layer.

25. The film structure according to claim 20, wherein the diluent is an acrylic monomer having a reactive functional group, and the solvent is ketones or esters.

26. The film structure according to claim 1, wherein the coating layer comprises nano-pigment black and a content of the nano-pigment black is 0.1% to 30% of the overall content of the coating layer.
